(19) United States
(12) Patent Application Publication
(10) Pub. No.: US 2024/0042715 A1
(43) Pub. Date: Feb. 8, 2024

(54) BLADDER CONTROL ASSEMBLY FOR TIRE CURING PRESS

(71) Applicant: LARSEN & TOUBRO LIMITED, Vedal (IN)

(72) Inventor: Ganesh Raja KARUPPUSAMY, Vedal (IN)

(21) Appl. No.: 17/880,779

(22) Filed: Aug. 4, 2022

(51) Int. Cl. B29D 30/06

(52) U.S. Cl. CPC B29D 30/0645; B29D 30/0662; B29D 2030/0647; B29D 2030/0665

(57) ABSTRACT

A bladder control assembly for a tire curing press includes an upper and lower clamp rings for clamping a bladder therebetween. The bladder is shaped with curing media to cure a tire enclosed between a top and bottom mold. An upper ring cylinder and one or more lower ring cylinders actuates the upper clamp ring and at least the lower clamp ring, respectively. A curing media supply and drain arrangement includes an outer pipe telescopically engaged to an inner pipe and the inner pipe is configured to supply the curing media to the bladder. The inner pipe moves within the outer pipe during actuation of the lower ring cylinders. The outer pipe is fixed to a cylinder guide by an outer pipe flange which is configured to house a seal provided at the area joining the outer pipe and the inner pipe.

### TECHNICAL FIELD

The disclosure generally relates to bladder control assemblies and mechanisms for handling bladders and tires in a tire curing press. Specifically, the disclosure relates to a center mechanism of a tire curing press that holds and lifts a bladder assembly.

### BACKGROUND

In a tire curing press, the uncured tire, often referred as the green tire, is placed in special molds where patterns, tread forming and side wall labelling of the tire occur during the curing operation. The mold arrangement normally includes a top mold and a bottom mold which are fastened within the structures of the tire curing press. In some cases, tire curing presses cure or vulcanize a tire by applying internal and external heat and pressure. A heated outer metal mold may shape and vulcanize the outside of the tire and a rubber tire curing bladder inflated in the inside of a tire carcass may be heated to vulcanize the interior of the tire.

A bladder control assembly configured as a center mechanism of the tire curing press acts as the operational interface between the press and a green tire being cured by the press, particularly during the operations of loading and unloading tires into the press. A commonly used center mechanism includes a bladder that is secured to the press and capable of being inserted within a tire band. The bladder can be radially inflated in order to apply curing pressure and heat to the interior of the tire band. For instance, the bladder may be filled with a higher-pressure medium, such as steam, hot water, inert gas, nitrogen gas, or the like with temperatures in the range of 200-300° C. and pressures around 350-450 psi. The bladder control assembly is further configured to strip the bladder from the tire after the curing process is completed.

### SUMMARY

Some aspects of the disclosure relate to a bladder control assembly for a tire curing press including an upper clamp ring and a lower clamp ring for clamping a bladder therebetween. The bladder can be shaped with curing media to cure a tire enclosed between a top mold and a bottom mold. The bottom mold is fixed to a platen supported by a platen support and a cylinder guide is connected to the platen support. An upper ring cylinder actuates the upper clamp ring and one or more lower ring cylinders actuates at least the lower clamp ring to strip the tire from the bottom mold. The bladder control assembly includes a curing media supply and drain arrangement having an outer pipe telescopically engaged to an inner pipe. The inner pipe is configured to supply the curing media to the bladder. The inner pipe is configured to move within the outer pipe during the actuation of the one or more lower ring cylinders to strip the tire from the bottom mold upon completion of curing. The outer pipe is fixed to the cylinder guide by an outer pipe flange configured to house a first seal provided at the area joining the outer pipe and the inner pipe, with a seal spacer securing the first seal.

Some other aspects of the disclosure relate to a tire curing press including the bladder control assembly as disclosed in one or more embodiments, wherein the bladder control assembly is removable in its assembled condition from a center cavity of the tire curing press.

In some embodiments, the bladder control assembly utilizes oil hydraulic system along with linear position sensing transducer devices and sealing systems to arrest leakage of the curing media from the bladder which is used for shaping tires in the tire curing press.

### BRIEF DESCRIPTION OF DRAWINGS

The various aspects of the disclosure will be discussed in greater detail with reference to the accompanying figures where,

FIG. 1 shows a cross-sectional front view of a bladder control assembly with a tire curing press in closed condition according to some embodiments;

FIG. 2 shows a cross-sectional side view of the bladder control assembly with the tire curing press in open condition and the bladder in stretched condition;

FIG. 3 shows a cross-sectional front view of the bladder control assembly with bladder in stretched condition and lower ring cylinders in extended condition;

FIGS. 4 and 5 show cross-sectional front views of the bladder control assembly according to some aspects of the disclosure;

FIG. 6 shows a cross-sectional top view of the bladder control assembly according to some aspects of the disclosure;

FIG. 7 shows a cross-sectional front view of the bladder control assembly including a seal according to some aspects of the disclosure;

FIG. 8 shows a cross-sectional bottom view of the bladder control assembly according to some aspects of the disclosure;

FIG. 9 shows assembled views of the bladder control assembly according to some embodiments;

FIGS. 10 and 11 show cross-sectional views of a cylinder guide according to some embodiments;

FIG. 12 shows a cross-sectional front view of the bladder control assembly including the telescopic supply and drain pipe assembly during bead lift (lower ring cylinder) operation;

FIG. 13 shows the utility connection to the bladder control assembly through rigid pipes from the plant outlet;

FIG. 14 shows the comparison of height between a conventional standing post bladder control assembly and the bladder control assembly according to one or more embodiments of this disclosure;

FIG. 15 shows a cross-sectional view of a tire curing press showing the bladder control assembly removal procedure using forklift and lifting fixture;

FIG. 16 shows the telescopic supply and drain pipe assembly for the bladder control assembly according to one or more embodiments of the disclosure; and

FIG. 17 shows the telescopic supply and drain pipe assembly mounted on the cylinder guide and lower clamp ring hub according to some embodiments;

The figures are not necessarily to scale. Like numbers used in the figures refer to like components. However, it will be understood that the use of a number to refer to a component in a given figure is not intended to limit the component in another figure labelled with the same number.

### DETAILED DESCRIPTION OF ILLUSTRATIVE EMBODIMENTS

In the following description, reference is made to the accompanying drawings that form a part hereof and in which various embodiments are shown by way of illustration. It is to be understood that other embodiments are contemplated and may be made without departing from the scope or spirit of the present description. The following detailed description, therefore, is not to be taken in a limiting sense.

A bladder control assembly is used in tire curing presses for handling and positioning bladders and stripping cured tires from a lower mold after the curing process. The bladder control assembly includes a simple arrangement of top ring and bottom ring (bead lift) actuating devices. Curing media such as steam, hot water, cold water, nitrogen, etc., is supplied, circulated and drained inside the bladder at a required pressure and temperature for a specific duration. When the curing media is applied into the bladder, and when the tire press is closed and locked, the bladder pushes the green tire towards the edges of the mold by swelling and distending. As the bladder pressure increases and presses the tire into the mold the tire takes on the tread patterns and sidewall letterings engraved into the mold. The tire is thus vulcanized and patterned according to the mold under high pressure and temperature. The cured tire is forcefully stripped or ejected from a lower mold, so as to enable the unloading of tire from the curing press.

The bladder control assembly may have a singular or plurality of pathways to supply and drain the curing media. Normally, flexible steam hoses are used to supply and drain the curing media inside the bladder. The flexible steam hoses are known to be frequently prone to failure or to cause hazardous accidents due to frequent actuation of the so-called bead lift cylinders. Also, typically bladder control assemblies must be disassembled before being removed from the curing press since it cannot be removed as a whole. Therefore, any maintenance to the bladder control assembly can only be carried out while being assembled to the curing press which is difficult and time consuming. The bladder control assembly according to one or more embodiments of the disclosure addresses these and other challenges.

The bladder control assembly according to one or more embodiments of the disclosure may be used in tire curing presses for curing two wheeler tires, light commercial vehicle (LCV) tires, passenger car tires (PCT), light truck, truck and bus tires. The bladder control assembly according to the disclosure can be used along with both segmented mold and two piece mold and is suitable for curing both radial and bias tires in all categories of tires.

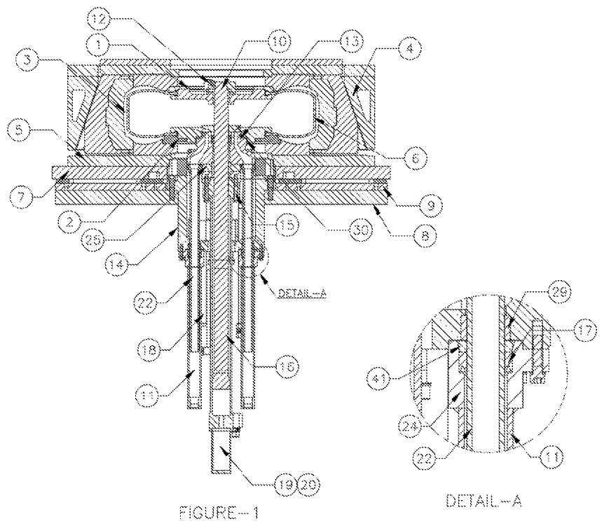

FIG. 1 illustrates the tire curing press in curing condition. As shown in FIG. 1, a bladder control assembly includes an upper clamp ring (1) and a lower clamp ring (2) for clamping a bladder (6) therebetween. The bladder (6) may be a rubber bladder, for instance made of butyl rubber or any number of suitable elastomeric materials well known to persons skilled in the art and may have the required thermal conductivity. The bladder (6) is inserted into a cavity of an uncured tire (3). The bladder (6) is usually constructed with a substantially uniform wall thickness to provide a substantially uniform transmittal of temperature and pressure to all portions internally of the uncured tire (3) that it comes in contact with. The uncured tire (3) is enclosed between a top mold (4) and a bottom mold (5). During vulcanization in a hydraulic curing press, the pressure applied by the bladder (6) on the tire (3) is maintained by applying pressure to the top (4) and bottom (5) molds using hydraulic cylinders.

The bottom mold (5) is mounted on a bottom platen (7) using a plurality of fasteners. The platen (7) is supported and secured by a bottom platen support (8) or a bolster using a plurality of fasteners as shown in FIG. 1. The bottom platen (7) and bottom platen support (8) are separated by an insulation plate (9), for instance a non-asbestos insulation plate. The top mold (4) may also be similarly mounted on a top platen (not shown) that may be selectively movable with respect to the bottom platen (7).

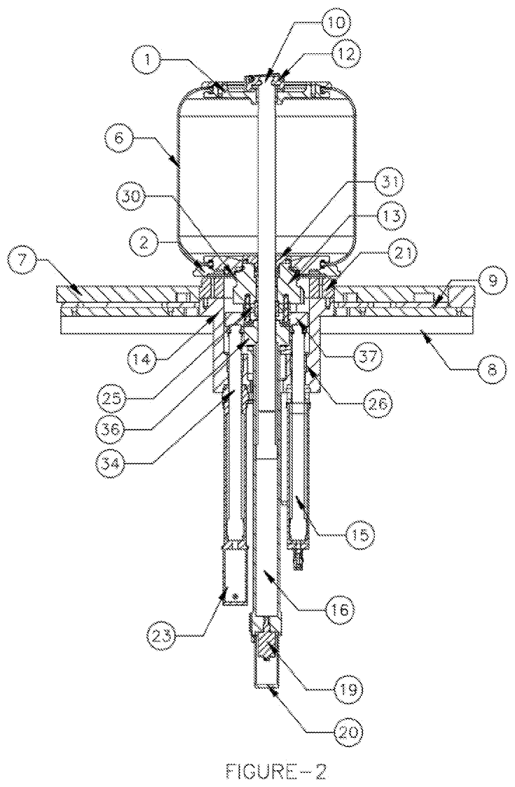

The upper clamp ring (1) and the lower clamp ring (2) are actuated by respective hydraulic cylinders. As shown best seen in FIGS. 1 and 2, an upper ring cylinder (16) is provided to actuate the upper clamp ring (1) and one or more lower ring cylinders (15) are provided to actuate the lower clamp ring (2). The one or more lower ring cylinders (15) are actuated to strip the cured tire from the bottom mold (5). The upper ring cylinder (16) includes an upper ring cylinder rod (10) and each of the one or more lower ring cylinders (15) includes a lower ring cylinder rod (34). The upper clamp ring (1) is fixed to the upper clamp ring cylinder rod (10) by means of a clamp 12 as shown in FIG. 2.

FIG. 1 shows the bladder control assembly in closed condition with the upper ring cylinder (16) and the one or more lower ring cylinders (15) in fully retracted condition. FIG. 2 shows the bladder control assembly in open condition with the upper ring cylinder (16) in fully extended condition and the one or more lower ring cylinders (15) in fully retracted condition.

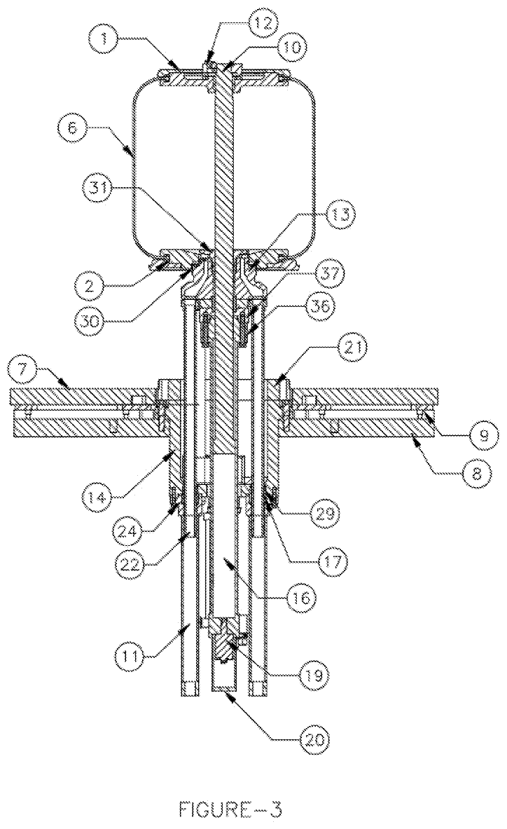

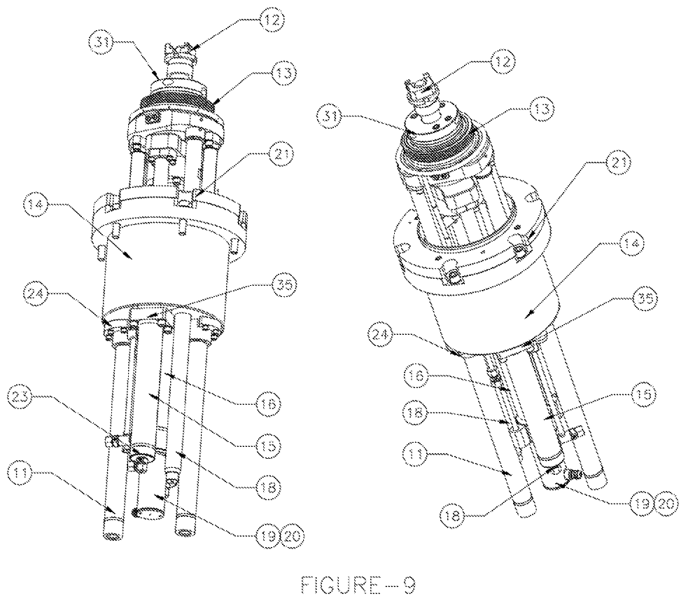

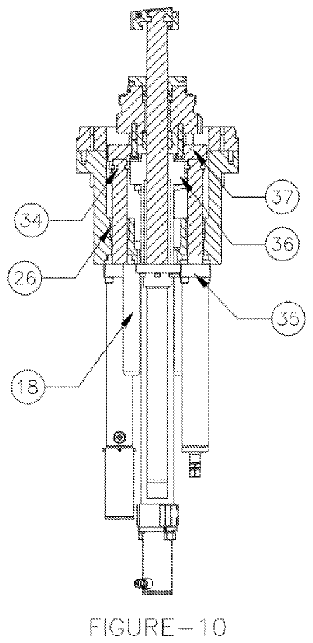

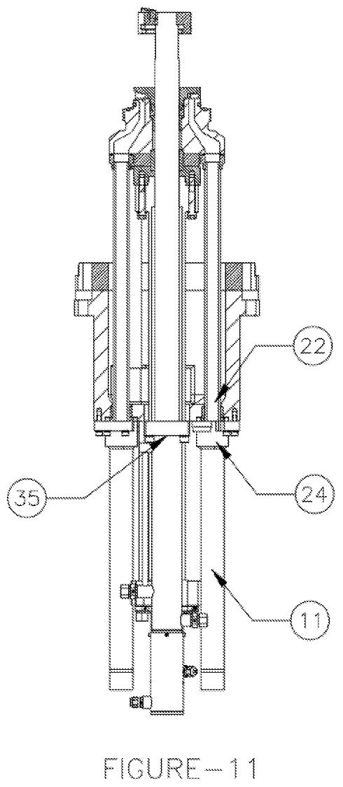

A cylinder guide (14) may be registered and fixed to the bottom platen support (8). A mold register ring (21) is fixed to an upper surface of the cylinder guide (14) as can be seen best in FIGS. 3 and 9 and the bottom mold (5) is registered to the mold register ring 21. In some embodiments, the cylinder guide (14) is adapted to provide a passage for slidable movement of the lower ring cylinder rod (34) of the one or more lower ring cylinders (15). As shown in FIGS. 2 and 10, a cylinder guide bush (26) may be housed within the cylinder guide (14) to guide the lower ring cylinder rod (34) during actuation of the one or more lower ring cylinders (15).

As shown in FIG. 2, the one or more lower ring cylinders (15) is mounted to the cylinder guide (14) and coupled with the upper ring cylinder (16) by a spacer flange (37). In some aspects, an end of the lower ring cylinder rod (34) of the one or more lower ring cylinders (15) is registered to the spacer flange (37). The spacer flange (37) is connected to an upper ring cylinder front flange (36) of the upper ring cylinder (16) and secured with a retainer and plurality of fasteners. According to this embodiment, since the one or more lower ring cylinders (15) are directly mounted to the cylinder guide (14) and coupled with the upper ring cylinder (16) by spacer flange (37), the total number of parts and the overall height of assembly are substantially reduced. In some cases, the one or more lower ring cylinders (15) and the upper ring cylinder (16) may be non-standard cylinders. In some aspects, the upper ring cylinder front flange (36) may be a nonstandard flange for ease of coupling with the one or more lower ring cylinders (15). Downward facing ports (33) may be provided for better hydraulic routing.

As shown in FIGS. 9 and 10, each of the one or more lower ring cylinders (15) may include a lower ring cylinder front flange (35) registered and mounted to cylinder guide (14) by means of a plurality of fasteners.

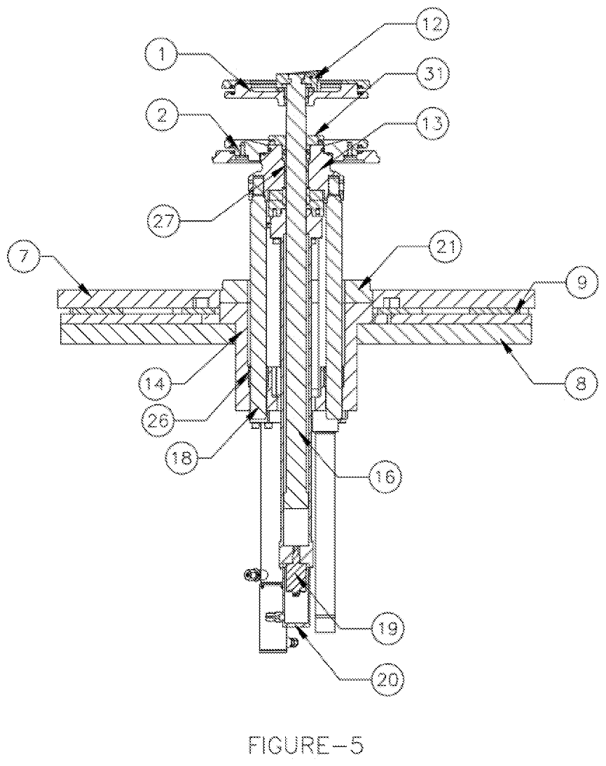

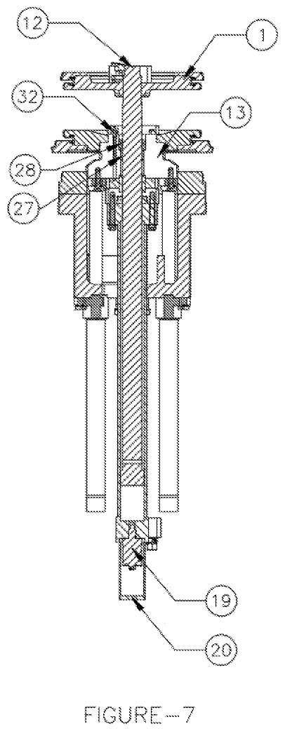

In some embodiments, the bladder control assembly may include a lower clamp ring hub (13) adapted to provide a passage for slidable movement of the upper ring cylinder rod (10) of the upper ring cylinder (16). As shown in FIGS. 5 and 7, a top ring cylinder rod bush (27) housed within the lower clamp ring hub (13) guides the upper ring cylinder rod (10) during actuation of upper ring cylinder (16). The top ring cylinder rod bush (27) also serves to overcome friction between the upper ring cylinder rod (10) and lower clamp ring hub (13). In some aspects, the lower clamp ring (2) may be threadingly connected to the lower clamp ring hub (13). For instance, the lower clamp ring (2) and the lower clamp ring hub (13) may have threads (30) and may be connected to each other by these threads (30). The lower clamp ring hub (13) may include a lower clamp ring hub insulation (25) as shown in FIG. 2.

According to an embodiment, during post curing operation, the one or more lower ring cylinders (15) actuates and lifts the upper ring cylinder (16), the lower clamp ring hub (13) and the lower clamp ring (2), thereby ejecting the tire (3) from the bottom mold (5).

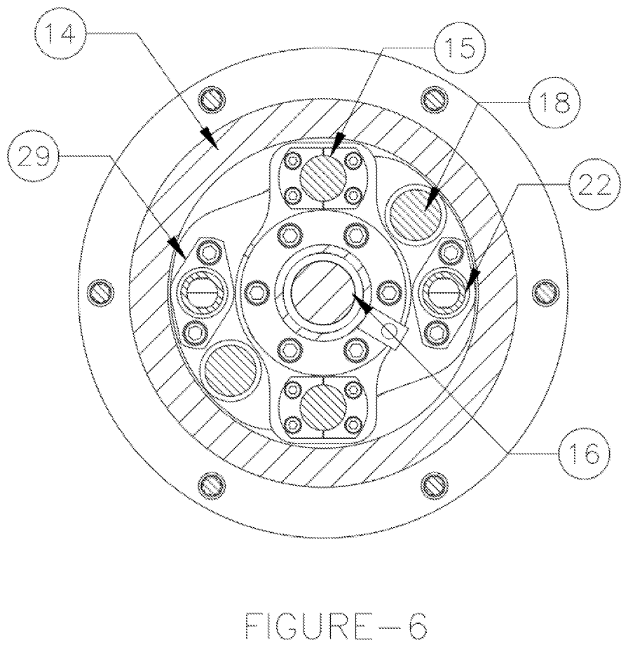

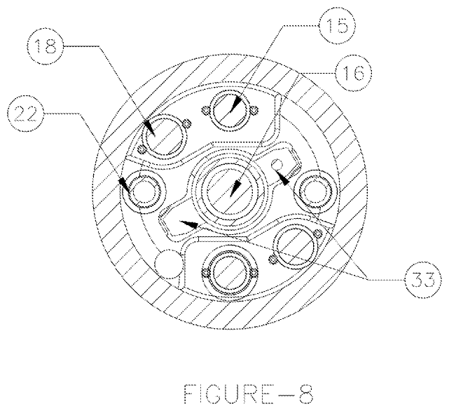

In some aspects, referring to FIGS. 6, 8 and 9, at least one cylinder guide shaft (18) may be provided to support the lower ring cylinder rods (34) of the one or more lower ring cylinders (15) during actuation. The cylinder guide bush (26) housed within the cylinder guide (14) guides the cylinder guide shaft (18) during actuation of the one or more lower ring cylinders (15). In some aspects, the cylinder guide shaft (18) may be threaded to the lower clamp ring hub (13) as can be seen in FIGS. 5 and 9. The cylinder guide bush (26) also serves to overcome friction during the actuation of the one or more lower ring cylinders (15) during stripping of the tire (3) post curing.

During the curing operation, the bladder (6) is filled and shaped with curing media to cure the tire (3). As previously stated, the curing media may be any higher-pressure medium, such as steam, hot water, inert gas, nitrogen gas, or the like with temperatures in the range of 200-300° C. and pressures around 350-450 psi. The curing media is supplied to the bladder (6) during the curing cycle and drained subsequent to the curing cycle using a curing media supply and drain arrangement as will be explained below.

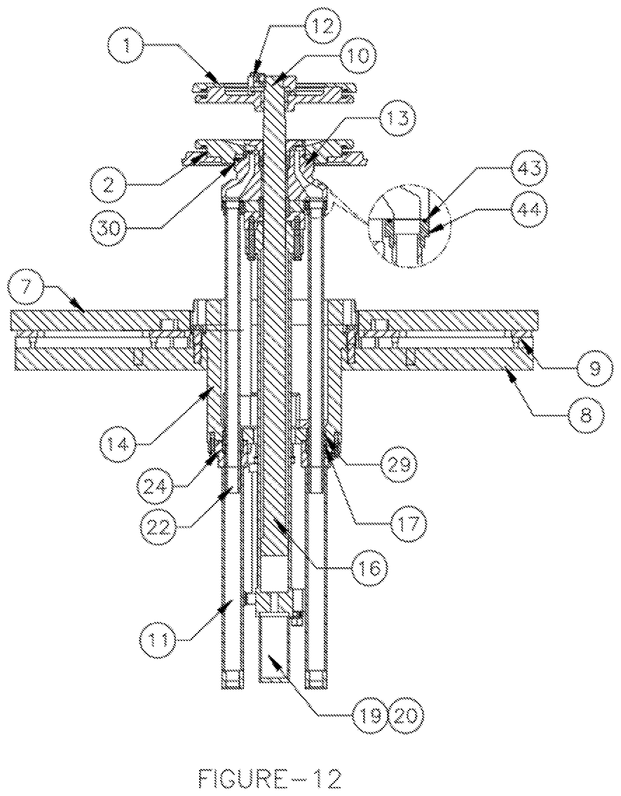

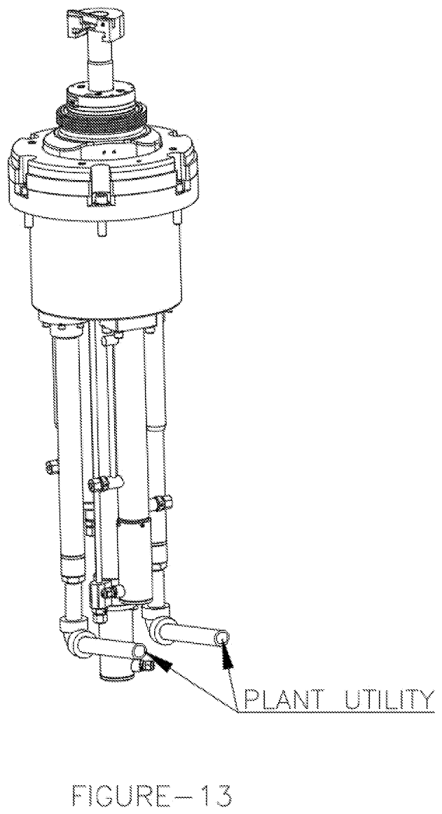

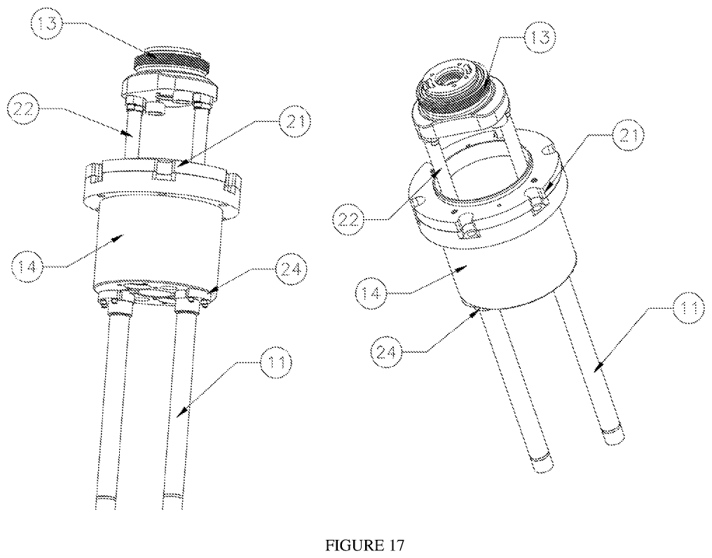

The curing media supply and drain arrangement according to one or more embodiments of the disclosure includes an outer pipe (11) telescopically engaged to an inner pipe (22) as shown in “Detail A” of FIG. 1 and also in FIGS. 3, 12 and 17. The inner pipe (22) is configured to supply the curing media to the bladder (6). During post curing operation, the inner pipe (22) is configured to move within the outer pipe (11) during the actuation of the one or more lower ring cylinders (15) to strip the tire (3) from the bottom mold (5). In some aspects, as best shown in FIGS. 1, 3 and 6, the cylinder guide (14) and a pipe bush (29) fixed at least partially inside the cylinder guide (14) guide the inner pipe (22) during a stroke of the one or more lower ring cylinders (15). As shown in FIG. 12, the inner pipe (22) is fastened to a lower clamp ring hub (13) by a plurality of fasteners.

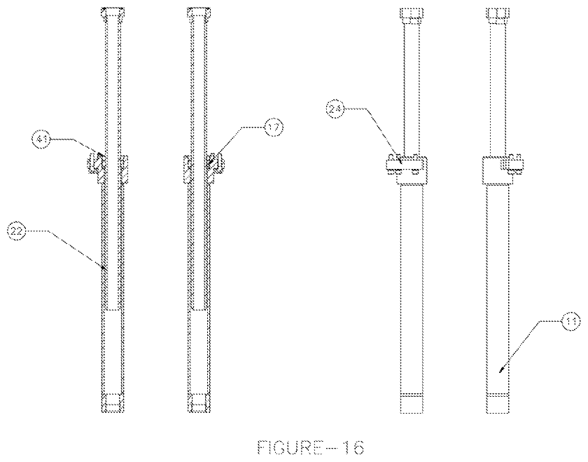

In some embodiments, as shown in FIGS. 9, 12 and 17, the outer pipe (11) is fixed to the cylinder guide (14) by an outer pipe flange (24). As can be seen in FIGS. 12 and 16, the outer pipe flange (24) may be configured to house a first seal (17) at the area joining the outer pipe (11) and the inner pipe (22). The first seal (17) is held securely in position by a seal spacer (41). The seal spacer (41) is also housed inside the outer steam pipe flange (24). The first seal (17) ensures that the curing media does not leak into the atmosphere during the actuation of the one or more lower ring cylinders (15) during stripping of the cured tire (3). The seal material of the first seal (17) is selected such that long life is ensured even while working under high temperature and pressure thereby ultimately reducing machine downtime.

In some embodiments, as shown in FIG. 12, at the area joining the inner pipe (22) with the lower clamp ring hub (13), a second seal (43) may be provided to prevent cure media from leaking into the atmosphere. In some aspects, the second seal (43) may be housed in an inner pipe flange (44) to ensure that the joint between the inner pipe flange (44) and the lower clamp ring hub (13) is leak proof. The seal material of the second seal (43) is selected such that long life is ensured even while working under high temperature and pressure thereby ultimately reducing machine downtime.

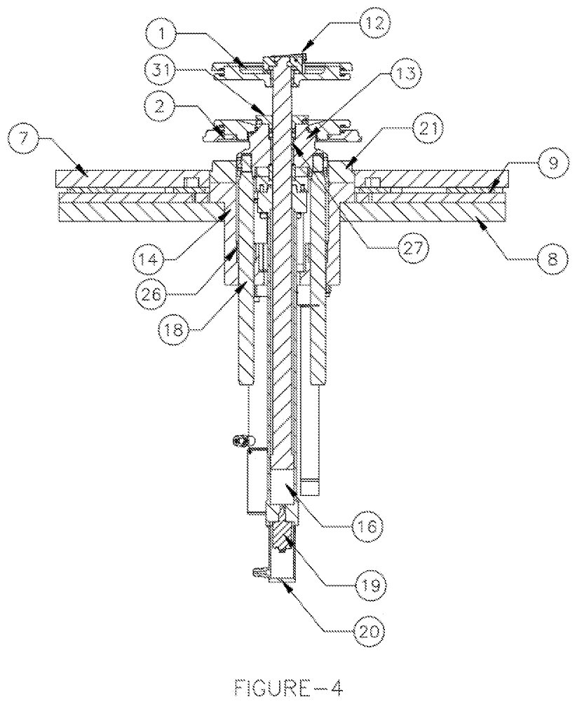

In some embodiments, as shown in FIG. 7, a third seal (28) may be provided to prevent leaking of the curing media inside the bladder (6) during curing of the tire (3). A retainer plate (31) is provided to securely retain the third seal (28) in its position, as illustrated in FIGS. 2-5 and 9. The seal material of the third seal (28) is selected such that long life is ensured even while working under high temperature and pressure thereby ultimately reducing machine downtime.

In some aspects, as best seen in FIG. 2, the position of the upper clamp ring (1) may be adjustable relative to the tire (3) using a first linear position sensing device (19). The first linear position sensing device (19) may be connected to the upper ring cylinder (16) to manipulate the position of the upper clamp ring (1) with respect to the tire (3). The exposed part of the first linear position sensing device (19) may be protected by means of a first linear position sensing device guard (20).

In some aspects, actuation of the one or more lower ring cylinders (15) may be sensed by a second linear position sensing device (23) which is connected to at least one of the one or more lower ring cylinders (15). In some cases, the second linear position sensing device (23) may be inbuilt in one or more of the lower ring cylinders (15).

As shown in FIG. 7, a temperature sensor (32) may be provided at the vicinity of the bladder (6) to sense the temperature of the curing media inside the bladder (6). In some instances, the temperature sensor (32) may be a resistance temperature detector (RTD).

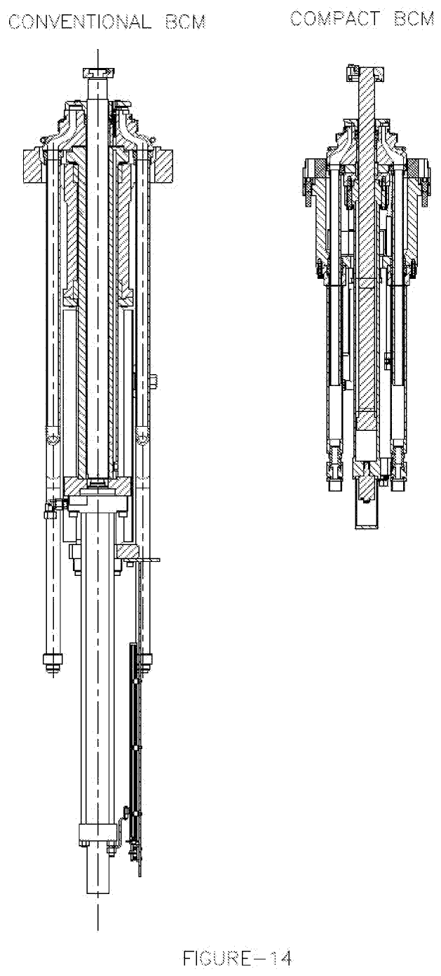

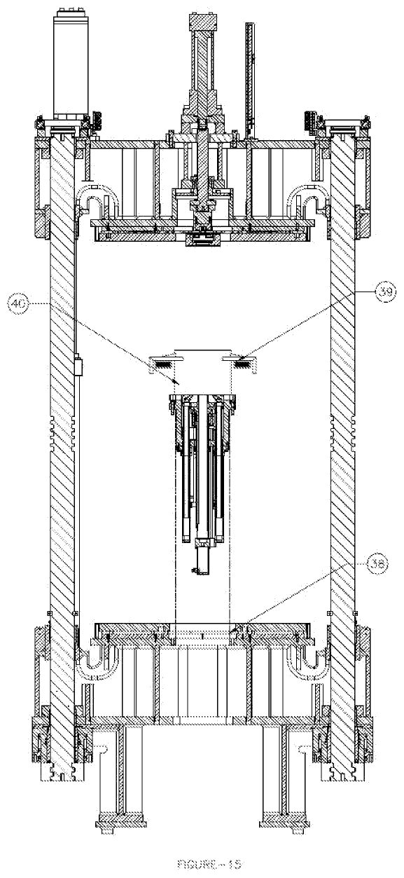

The bladder control assembly, or the center mechanism, according to one or more embodiments of this disclosure is compact and shorter in height when compared with the conventional assemblies. A comparison of the height of conventional bladder control assemblies and the bladder control assembly according to this disclosure can be seen in FIG. 14. Further, the bladder control assembly according to this disclosure is capable of being removed in its assembled condition from a center cavity (38) of the tire curing press as shown in FIG. 15 since no part of the bladder control assembly is projected beyond the central cavity (38). This bladder control mechanism according to this disclosure can be lifted in its assembled condition using a forklift (39) by coupling with a lifting fixture (40) of the bladder control assembly.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A bladder control assembly for a tire curing press comprising:
an upper clamp ring and a lower clamp ring for clamping a bladder therebetween, said bladder being shaped with curing media to cure a tire enclosed between a top mold and a bottom mold;
the bottom mold is fixed to a platen supported by a platen support and a cylinder guide is connected to the platen support;
an upper ring cylinder for actuating the upper clamp ring;
one or more lower ring cylinders for actuating at least the lower clamp ring to strip the tire from the bottom mold;
a curing media supply and drain arrangement comprising an outer pipe telescopically engaged to an inner pipe, the inner pipe configured to supply the curing media to the bladder;
the inner pipe is configured to move within the outer pipe during the actuation of the one or more lower ring cylinders to strip the tire from the bottom mold upon completion of curing; and
the outer pipe is fixed to the cylinder guide by an outer pipe flange, the outer pipe flange being configured to house a first seal provided at the area joining the outer pipe and the inner pipe, and a seal spacer securing the first seal.

2. The bladder control assembly according to claim 1, wherein the inner pipe is fastened to a lower clamp ring hub, and a second seal is housed in an inner pipe flange to prevent cure media from leaking.

3. The bladder control assembly according to claim 2, wherein the lower clamp ring hub is adapted to provide a passage for slidable movement of an upper ring cylinder rod of the upper ring cylinder.

4. The bladder control assembly according to claim 3, wherein a top ring cylinder rod bush housed within the lower clamp ring hub guides the upper ring cylinder rod during actuation of upper ring cylinder.

5. The bladder control assembly according to claim 1, wherein the cylinder guide is adapted to provide a passage for slidable movement of a lower ring cylinder rod of the one or more lower ring cylinders.

6. The bladder control assembly according to claim 5, wherein a cylinder guide bush housed within the cylinder guide guides the lower ring cylinder rod during actuation of the one or more lower ring cylinders.

7. The bladder control assembly according to claim 1, wherein the bottom mold is registered to a bottom mold register ring fixed to an upper surface of the cylinder guide.

8. The bladder control assembly according to claim 1, wherein the cylinder guide and a bush guide the inner pipe during a stroke of the one or more lower ring cylinders.

9. The bladder control assembly according to claim 1, wherein the one or more lower ring cylinders is mounted to the cylinder guide and coupled with the upper ring cylinder by a spacer flange.

10. The bladder control assembly according to claim 1, wherein at least one cylinder guide shaft is provided to support the one or more lower ring cylinders during actuation, and a cylinder guide bush housed within the cylinder guide guides the cylinder guide shaft during actuation of the one or more lower ring cylinders.

11. The bladder control assembly according to claim 10, wherein the cylinder guide shaft is threaded to a lower clamp ring hub.

12. The bladder control assembly according to claim 1, wherein each of the one or more lower ring cylinders comprises a lower ring cylinder front flange mounted to the cylinder guide, and the upper ring cylinder comprises an upper ring cylinder front flange for coupling with the one or more lower ring cylinders by a spacer flange.

13. The bladder control assembly according to claim 12, wherein each of the one or more lower ring cylinders comprises a lower ring cylinder rod registered to the spacer flange, said spacer flange being connected to an upper ring cylinder front flange.

14. The bladder control assembly according to claim 1, wherein the lower clamp ring is threadingly connected to a lower clamp ring hub.

15. The bladder control assembly according to claim 1, comprising a first linear position sensing device having a first linear position sensing device guard.

16. The bladder control assembly according to claim 15, wherein the first linear position sensing device is connected to the upper ring cylinder, the position of upper clamp ring is adjustable relative to the tire using the first linear position sensing device.

17. The bladder control assembly according to claim 1, comprising a second linear position sensing device connected to at least one of the one or more lower ring cylinders.

18. The bladder control assembly according to claim 1, comprising a temperature sensor to sense the temperature of the curing media inside the bladder.

19. The bladder control assembly according to claim 1, comprising a third seal to prevent leaking of the curing media inside the bladder during curing of the tire, said third seal positionally retained by a retainer plate.

20. A tire curing press comprising the bladder control assembly according to claim 1, wherein the bladder control assembly is removable in its assembled condition from a center cavity of the tire curing press.
